(19) United States
(12) Patent Application Publication
(10) Pub. No.: US 2010/0134465 A1
(43) Pub. Date: Jun. 3, 2010

(54) Plasma display device and driving method thereof

(76) Inventors: Jung-Soo An, Suwon-si (KR); Jang-Ho Moon, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/591,775

(22) Filed: Dec. 1, 2009

(30) Foreign Application Priority Data
Dec. 1, 2008 (KR) 10-2008-0120665

(51) Int. Cl. G09G 5/00

(52) U.S. Cl. 345/211

(57) ABSTRACT

A driving system and method for use with a plasma display device, which includes a plurality of first electrodes and a plurality of second electrodes that perform display operation with the plurality of first electrodes, selectively applies a first voltage to the plurality of first electrodes and applies a second voltage that is higher than the first voltage to first electrodes to which the first voltage is not applied during an address period of a first subfield having the lowest weight value among the plurality of subfields, applies a third voltage that corresponds to a voltage difference between the first voltage and the second voltage to the plurality of first electrodes during a first period of a sustain period, and applies a fourth voltage that is lower than the third voltage to the plurality of second electrodes during the first period.

### BACKGROUND

1. Field of the Invention

Embodiments relate to a plasma display device and driving method thereof.

2. Description of the Related Art

A plasma display device is a display device using a plasma display panel (PDP) for displaying characters or images by using plasma generated by gas discharge. The PDP has a plurality of discharge cells arranged in a matrix format.

In general, in the plasma display device, one frame is divided into a plurality of subfields with luminance weight values. Cells are reset through reset discharging during a reset period of each subfield, and light emitting cells and non light emitting cells are selected by address discharging during an address period. During a sustain period, sustain discharging occurs at the light emitting cells by the number of times corresponding to a weight value of the corresponding subfield and images are displayed.

The plasma display device is advantageous in expressing low grayscales, wherein light emitted in a subfield for expressing the minimum grayscale, e.g., 1, is referred to as unit light. However, ignoring light generated in the reset period, the brightness of the unit light is determined by the sum of the light generated by the address discharge and the light generated by the sustain discharge in the subfield for expressing the minimum grayscale. Therefore, the unit light may become too bright, so that low grayscales may not be normally expressed.

The above information disclosed in this Background section is only for enhancement of understanding of the background of the invention and therefore it may contain information that does not form the prior art that is already known in this country to a person of ordinary skill in the art.

### SUMMARY

Embodiments are therefore directed to a plasma display device and driving method thereof, which substantially overcome one or more of the problems due to the limitations and disadvantages of the related art.

It is therefore a feature of an embodiment to provide a plasma display device and a driving system and method thereof, improving expression of a low grayscale.

It is another feature of an embodiment to provide a plasma display device and a driving system and method thereof, that reduces a unit light.

It is yet another a feature of an embodiment to provide a plasma display device and a driving system and method thereof, that reduces the amount of light from sustain discharge by controlling a voltage applied to a scan electrode or a sustain electrode during a sustain period of a subfield that has a lowest weight value.

At least one of the above and other features and advantages may be realized by providing a method for driving a plasma display device including a plurality of first electrodes and a plurality of second electrodes that perform display operations with the plurality of first electrodes according to an exemplary embodiment of the present invention divides one frame into a plurality of subfields. The method includes, in a first subfield having the lowest weight value among the plurality of subfields, during an address period, selectively applying a first voltage to the plurality of first electrodes and applying a second voltage that is higher than the first voltage to first electrodes to which the first voltage is not applied; during a first period of a sustain period, applying a third voltage that corresponds to a voltage difference between the first voltage and the second voltage to the plurality of first electrodes; and during the first period, applying a fourth voltage that is lower than the third voltage to the plurality of second electrodes.

At least one of the above and other features and advantages may be realized by providing a driving system for use with a plasma display device including a first electrode, the driving system having a first driver connected to the first electrode. The first driver includes a scan circuit having a first input terminal, a second input terminal, and an output terminal, the output terminal connected to the first electrode, a first transistor connected between a first power source that supplies a first voltage and the second input terminal, a second transistor connected between a second power source that supplies a second voltage that is higher than the first voltage and the second input terminal, and a capacitor having a first end connected to the first input terminal, a second end connected to the second input terminal, and charged with a third voltage. The first driver turns on the first transistor to apply a voltage at the first input terminal to the first electrode during a first period of a sustain period of a first subfield among a plurality of subfields.

At least one of the above and other features and advantages may be realized by providing a driving system for use with a plasma display device including a plurality of first electrodes, a plurality of second electrodes that perform display operations with the plurality of first electrodes, and a controller that divides one frame into a plurality of subfields. The driving system includes a first driver and a second driver. The first driver selectively applies a first voltage to the plurality of first electrodes and applies a second voltage that is higher than the first voltage to first electrodes to which the first voltage is not applied during an address period of a first subfield among the plurality of subfields, and applies a third voltage to the plurality of first electrodes during a first period of a sustain period of the first subfield, the third voltage corresponding to a voltage difference between the second voltage and the first voltage. The second driver applies a fourth voltage that is lower than the third voltage to the plurality of second electrodes during the first period.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a plasma display device according to an exemplary embodiment of the present invention;

FIG. 2 to FIG. 4 illustrate driving waveforms of the plasma display device according to the exemplary embodiment of the present invention;

FIG. 5 schematically illustrates a scan electrode driver according to the exemplary embodiment of the present invention; and

FIG. 6A to FIG. 6C illustrate operation of the scan electrode driver when driving waveforms according to the exemplary embodiment of the present invention are applied.

### DETAILED DESCRIPTION

Korean Patent Application No. 10-2008-0120665, filed on Dec. 1, 2008, in the Korean Intellectual Property Office, and entitled: “Plasma Display Device and Driving Method Thereof,” is incorporated by reference herein in its entirety.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising”, will be understood to imply the inclusion of stated elements but not the exclusion of any other elements.

Further, “wall charges” that are described in this specification indicate charges that are formed adjacent to each electrode on a wall (e.g., a dielectric layer) of a cell. Although the wall charges do not actually touch the electrodes, the wall charge will be described as being “formed” or “accumulated” on the electrode. A wall voltage is a potential difference formed on the wall of the discharge cell by the wall charges.

A plasma display device according to an exemplary embodiment of the present invention, and a driving method thereof will be described in further detail with reference to the drawings.

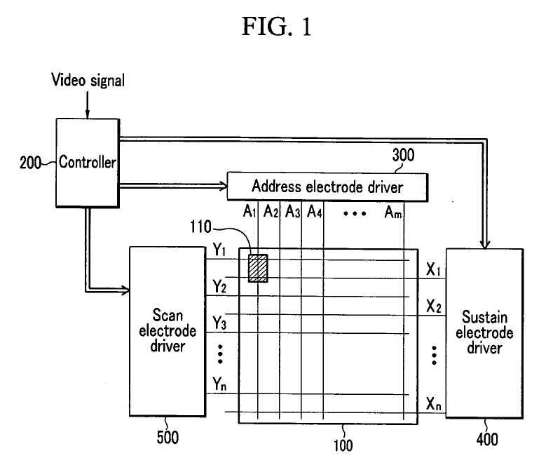

FIG. 1 illustrates a plasma display device according to an exemplary embodiment of the present invention. As shown in FIG. 1, the plasma display device may include a PDP 100, a controller 200, an address electrode driver 300, a sustain electrode driver 400, and a scan electrode driver 500.

The PDP 100 may include a plurality of address electrodes A₁ to Aₘ extending in a column direction, and a plurality of sustain and scan electrodes X₁ to Xₙ and Y₁ to Yn extending in a row direction by pairs. Hereinafter, an address electrode, a sustain electrode, and a scan electrode will be respectively referred to as an A electrode, an X electrode, and a Y electrode. Generally, the sustain electrodes X₁ to Xₙ may be formed in correspondence to the respective scan electrodes Y₁ to Yₙ, and the X electrodes X₁ to Xₙ and the Y electrodes Y₁ to Yₙ perform a display operation in the sustain period for displaying images. The Y electrodes Y₁ to Yₙ and the X electrodes X₁ to Xₙ may perpendicularly cross the A electrodes A₁ to Aₘ. In this case, a discharge space formed at a crossing region of the A electrodes A₁ to Aₘ and the X and Y electrodes X₁ to Xₙ and Y₁ to Yₙ forms a discharge cell 110. This is an exemplary structure of the PDP 100, and panels of other structures may be used with embodiments discussed below.

The controller 200 may receive external video signals and output an A electrode driving control signal, an X electrode driving control signal, and a Y electrode driving control signal. In addition, the controller 200 may divide one frame into a plurality of subfields and drive the subfields. Each subfield may include a reset period, an address period and a sustain period with respect to time.

The reset period may reset a plurality of cells 110. During the address period, light emitting cells and non-light emitting cells may be selected. During the sustain period, sustain discharges may be generated a number of times corresponding to a weight value of a corresponding subfield in the light emitting cells. In this case, a grayscale of each cell may be determined by a combination of weights of subfields. Some of the plurality of subfields may not include the reset period.

The controller 200 may change the video signal into subfield data that indicates the light emitting state in each subfield, and may generate the A electrode driving control signal, the Y electrode driving control signal, and the X electrode driving control signal according to the subfield data and the number of sustain discharge generations in each subfield.

The address electrode driver 300 may receive the A electrode driving control signal from the controller 200 and may apply a display data signal to each of the A electrodes A1 to Am for selecting light emitting cells. The sustain electrode driver 400 may receive the X electrode driving control signal from the controller 200 and may apply a driving voltage to an X electrode. The scan electrode driver 500 may receive the Y electrode driving control signal from the controller 200 and may apply the driving voltage to a Y electrode.

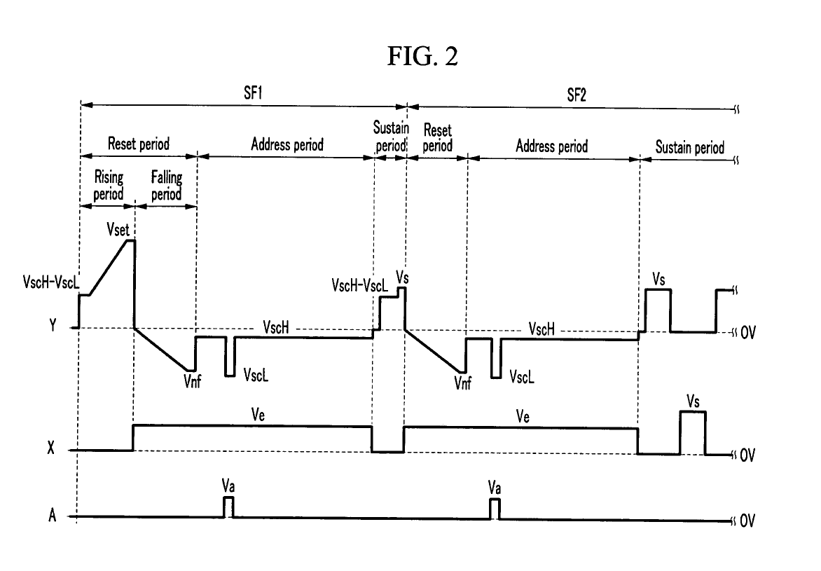

FIG. 2 to FIG. 4 respectively illustrates driving waveforms of the plasma display device according to an exemplary embodiment of the present invention. For better understanding and ease of description, FIG. 2 to FIG. 4 only show driving waveforms of the first and second subfields SF1 and SF2 among the plurality of subfields, and the driving waveforms will be described based on a cell formed by one X electrode, one Y electrode, and one A electrode.

As shown in FIG. 2, according to the exemplary embodiment of the present invention, the address electrode driver 300 and the sustain electrode driver 400 respectively bias the A electrode and the X electrode with a reference voltage (0V in FIG. 2) and the scan electrode driver 500 gradually increases a voltage of the Y electrode to a Vset voltage from a (VscH−VscL) voltage during a reset period of the first subfield SF1. In FIG. 2, the voltage of the Y electrode is increased in a ramp pattern. While the voltage of the Y electrode increases, a weak discharge may be generated between the Y electrode and the X electrode, and between the Y electrode and the A electrode. Therefore negative wall charges (−) may be formed on the Y electrode and positive wall charges (+) may be formed on the X electrode and the A electrode. In this case, the Vset voltage may be set to be higher than a discharge firing voltage between the X and Y electrode for occurrence of discharge in all the cells. Here, a (VscH−VscL+Vs) voltage corresponding to a difference between a Vs voltage and a (VscH−VscL) voltage applied to the Y electrode during a sustain period may be used as the Vset voltage. Instead of the (VscH−VscL) voltage, another voltage, e.g., the Vs voltage may be used.

Subsequently, the sustain electrode driver 400 may bias the X electrode with a Ve voltage, and the scan electrode driver 500 may gradually decrease the voltage of the Y electrode from 0V voltage to a Vnf voltage. In FIG. 2, the voltage of the Y electrode is decreased in a ramp pattern. Then, a weak discharge may occur between the Y electrode and the X electrode, and between the Y electrode and the A electrode while the voltage of the Y electrode is decreased. Thus, the negative (−) wall charges formed on the Y electrode and the positive (+) wall charges formed on the X and A electrodes may be erased. In general, the Ve voltage and the Vnf voltage may be set for a wall voltage between the Y and X electrodes to be close to the 0V voltage in order to prevent the sustain discharge from being generated during the sustain period in a cell that is not selected during the address period. That is, a (Ve−Vnf) voltage may be set to be close to the discharge firing voltage between the Y electrode and the X electrode. In this case, the voltage of the Y electrode may be set to a voltage other than 0V voltage, e.g., the voltage of the Y electrode may be gradually decreased from the Vs voltage to the Vnf voltage.

For selecting light emitting cells to be turned on during an address period, the sustain electrode driver 400 may maintain a voltage of the X electrode with the Ve voltage, and the scan electrode driver 500 and the address electrode driver 300 may respectively apply a scan pulse having the VscL voltage and an address pulse having an Va voltage to the Y and A electrodes. In this case, a Y electrode of an unselected light emitting cell may be biased with a VscH voltage that is higher than the VscL voltage, and an A electrode of non-light emitting cell may have a reference voltage applied thereto. Herein, the VscL voltage may be the same as or lower than the Vnf voltage.

In further detail, during the address period, the scan electrode driver 500 and the address electrode driver 300 may apply the scan pulse to a first row Y electrode Y1 and the address pulse to the A electrode positioned in the light emitting cell in a first row. Then, an address discharge is generated between the first row Y electrode Y1 and the A electrode to which the address pulse is applied. Thus, the positive (+) wall charges are formed on the Y electrode Y1 and the negative (−) wall charges are formed on the A and X electrodes. Subsequently, the scan electrode driver 500 and the address electrode driver 300 may apply the scan pulse to a second row Y electrode Y2 and the address pulse to the A electrode positioned on the light emitting cell of a second row. Then, a discharge is generated in a cell formed by the second row Y electrode Y2 and the A electrode to which the address pulse is applied so that the wall charges are formed in the cell. In a like manner, the scan electrode driver 500 and the address electrode driver 300 sequentially apply the scan pulse to remaining Y electrodes and apply the address pulse to the A electrode positioned on the light emitting cell to form the wall charges.

During the sustain period, the scan electrode driver 500 may apply a voltage that is lower than the Vs voltage to the Y electrode. In this case, the (VscH−VscL) voltage that corresponds to a difference between the VscH voltage and the VscL voltage used during the address period may be used as the voltage that is lower than the Vs voltage. In this way, an additional power source for supplying the voltage that is lower than the Vs voltage may not be required. In addition, while the (VscH−VscL) voltage is applied to the Y electrode, the sustain electrode driver 400 may apply 0V voltage to the X electrode. Then, a voltage difference between the X and Y electrodes may be decreased compared to the case that the X electrode and the Y electrode are respectively applied with 0V voltage and the Vs voltage so that a weak sustain discharge is generated. Accordingly, the amount of light output by the sustain discharge may be reduced.

In this case, in order make generation of a reset discharge during a reset period of the next subfield SF2 easier, the Vs voltage may be applied to the Y electrode after the (VscH−VscL) voltage is applied thereto. Then, space charges formed by the sustain discharge may be additionally formed on the Y electrode, the X electrode, and the A electrode.

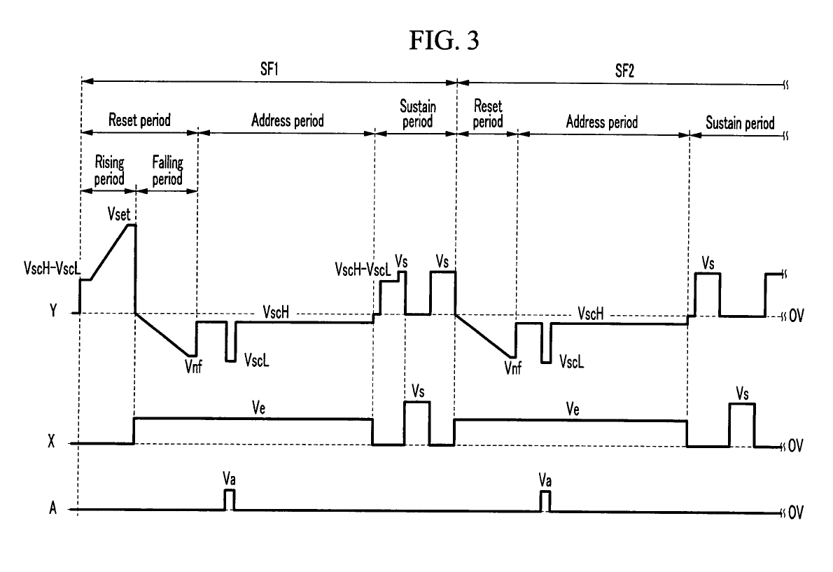

In FIG. 2, one sustain discharge pulse is applied to the Y electrode during the sustain period of the first subfield SF1, but it is not limited thereto. That is, a plurality of sustain pulses may be applied to the Y electrode and/or the X electrode. For example, as shown in FIG. 3, after a sustain discharge pulse having the Vs voltage is applied to the X electrode, the sustain discharge pulse having the Vs voltage may be applied to the Y electrode. In this case, a sustain pulse having the (VscH−VscL) voltage may be used instead of the sustain pulse having the Vs voltage.

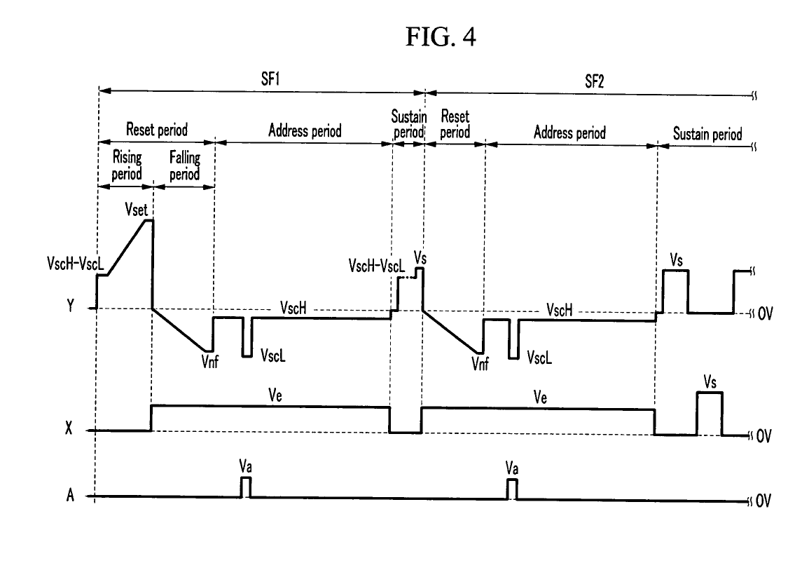

Referring to FIG. 4, during a sustain period of a first subfield SF1 according to another exemplary embodiment of the present invention, the scan electrode driver 500 may float the Y electrode after applying the (VscH−VscL) voltage to the Y electrode. Due to the floating, the amount of light by sustain discharge may be reduced.

Subsequently, during a falling period of a reset period of the second subfield SF2, the sustain electrode driver 400 may bias the X electrode with the Ve voltage and the scan electrode driver 500 may gradually decrease the voltage of the Y electrode from 0V voltage to the Vnf voltage. In this case, if the sustain discharge is generated during the sustain period of the first subfield SF1, the negative (−) wall charges are formed on the Y electrode and the positive (+) wall charges are formed on the X and A electrodes. Accordingly, weak discharge is generated between the Y and X electrode and between the Y and A electrode while the voltage of the Y electrode is gradually decreased as in the falling period of the reset period of the first subfield SF1, so that the negative (−) wall charges formed on the Y electrode and the positive (+) wall charges formed on the X and A electrodes are erased and the discharge cells are reset.

In addition, in all of the embodiments illustrated in FIGS. 2 to 4, during an address period of the second subfield SF2, light emitting cells are selected as in the address period of the first subfield SF1 and sustain discharge is performed on the light emitting cells during a sustain period. In this case, a sustain discharge pulse having the Vs voltage may be used during the sustain period of the second subfield SF2. Further, the first period of the sustain period of the first subfield SF1 during which the (VscH−VscL) voltage is applied, may be longer than either period during which the 0V voltage and the Vs voltage are applied. For example, the first period may be longer than both these periods combined, e.g., the first period may be a majority of the sustain period.

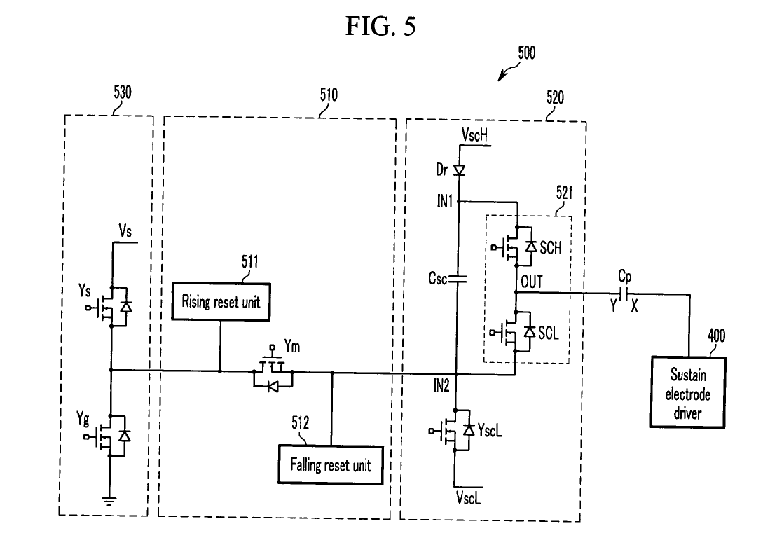

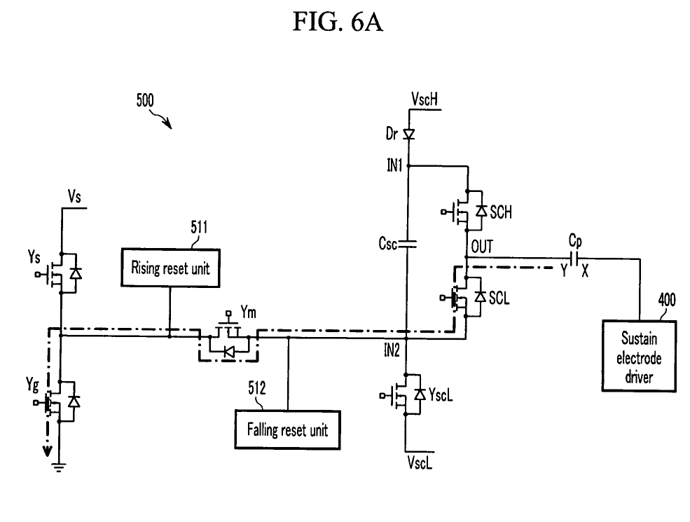

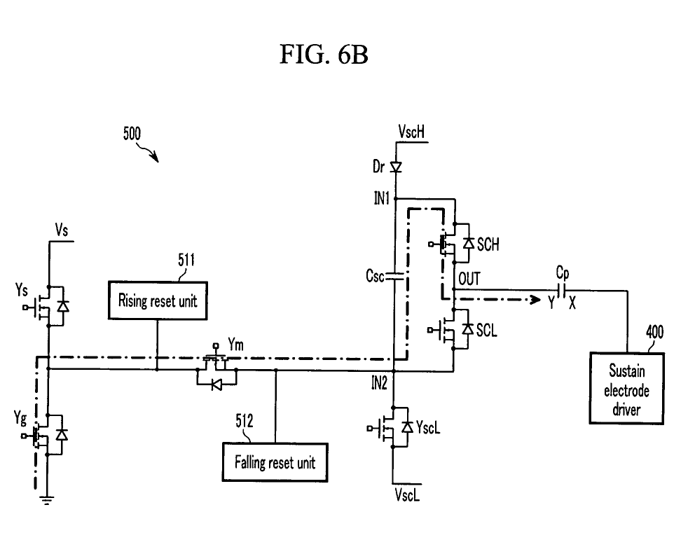

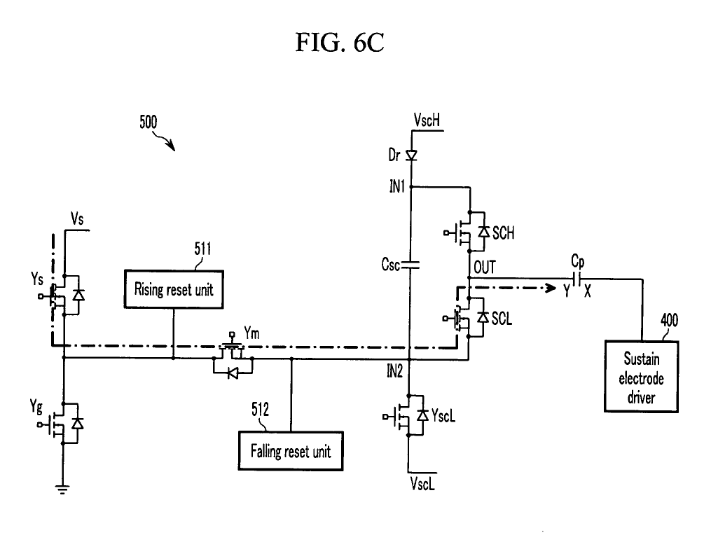

Hereinafter, referring to FIG. 5, and FIG. 6A to FIG. 6C, a method for reducing the amount of light by sustain discharge during a sustain period of a subfield that expresses the minimum grayscale will be described in further detail.

FIG. 5 schematically illustrates a scan electrode driver according to an exemplary embodiment of the present invention. FIG. 6A to FIG. 6C illustrate operation of the scan electrode driver when driving waveforms are applied according to the exemplary embodiment of the present invention.

In FIG. 5, only one Y electrode Y and one X electrode X are shown for better understanding and ease of description, and a capacitive component formed by the Y electrode Y and the X electrode X is shown as a panel capacitor Cp. In addition, in FIG. 5, transistors Ys, Yg, Ym, YscL, SCH, and SCL are shown as n-channel field effect transistors, and particularly, as n-channel metal oxide semiconductor (NMOS) transistors, and a body diode may be formed from a source to a drain direction in each of the transistors Ys, Yg, Ym, YscL, SCH, and SCL. Other switches having the same or a similar function may be used as the transistors Ys, Yg, Ym, YscL, SCH, and SCL. Further, in FIG. 5, the transistors Ys, Yg, Ym, YscL, SCH, and SCL are each illustrated as a single transistor, but they may be formed as a plurality of transistors connected in parallel.

As shown in FIG. 5, a driving circuit of a plasma display device may include the sustain electrode driver 400 and the scan electrode driver 500. The scan electrode driver 500 may include a reset driver 510, a scan driver 520, and a sustain driver 530.

The scan driver 520 may generate a scan pulse during an address period. The scan driver 520 may include a capacitor Csc, a diode Dr, and a plurality of scan circuits 521. In FIG. 5, only one scan circuit 521 connected to one Y electrode is shown, but each of the plurality of Y electrodes may be connected to a scan circuit. In addition, a plurality of scan circuits may be formed as one integrated circuit.

In the scan driver 520, a power source VscH that supplies a VscH voltage may be connected to an anode of the diode Dr and a cathode of the diode Dr may be connected to a first end of the capacitor Csc. A second end of the capacitor Csc may be connected to a first end (i.e., drain) of the transistor YscL and a second end (i.e., source) of the transistor YscL may be connected to a power source VscL that supplies a VscL voltage. In this case, a (VscH−VscL) voltage that corresponds to a voltage difference between the VscH voltage supplied from the power source VscH and the VscL voltage supplied from the power source VscL may be stored in the capacitor Csc.

The scan circuit 521 may include two transistors SCH and SCL, a high voltage input terminal IN1, a low voltage input terminal IN2, and an output terminal OUT. A first end (i.e., drain) of the transistor SCH may be connected to the high voltage input terminal IN1 and a second end (i.e., source) thereof may be connected to the Y electrode through the output terminal OUT. A first end (i.e., drain) of the transistor SCL may be connected to the Y electrode through the output terminal OUT and a second end (i.e., source) thereof may be connected to the low voltage input terminal IN2. The high voltage input terminal IN1 of the scan circuit 521 may be connected to a cathode of the diode Dr and the first end of the capacitor Csc. The low voltage input terminal IN2 may be connected to the second end of the capacitor Csc and the drain of the transistor YscL.

The reset driver 510 may generate a reset pulse in a reset period. The reset driver 510 may include a rising reset unit 511, a falling reset unit 512, and a transistor Ym. The falling reset unit 512 may be connected to the low voltage input terminal IN2 and the rising reset unit 511 may be connected to the low voltage input terminal IN2 through the transistor Ym. The rising reset unit 511 may gradually increase a voltage of the Y electrode from the (VscH−VscL) voltage to a Vset voltage during a rising period of the reset period. The falling reset unit 512 may gradually decrease the voltage of the Y electrode from 0V voltage to the Vnf voltage during a falling period of the reset period. The transistor Ym may be provided to prevent a current applied to the panel capacitor Cp from being reversed.

The sustain driver 530 may generate a sustain pulse in a sustain period. The sustain driver 530 may include transistors Ys and Yg. In the sustain driver 530, a first end (i.e., drain) of the transistor Ys may be connected to a power source Vs that supplies a Vs voltage, a second end (i.e., source) of the transistor Ys may be connected to a first end (i.e., drain) of the transistor Yg, and a second end (i.e., source) of the transistor Yg may be connected to a power source (i.e., ground end) that supplies 0V voltage. In addition, a node between the second end of the transistor Ys and the first end of the transistor Yg may be connected to the rising reset unit 511 of the reset driver 510.

Hereinafter, operation of the scan electrode driver for reducing the amount of light of sustain discharge during a sustain period of a subfield that expresses the minimum grayscale will be described in further detail.

Referring to FIG. 5 and FIG. 6A, the scan driver 520 of the scan electrode driver 500 may control the transistors SCH and SCL of the scan circuit 521 to apply a sustain discharge pulse to the Y electrode when an address period of the subfield SF1 is changed to a sustain period.

In further detail, during the address period, the transistor SCH is turned on and the transistor SCL is turned off when the scanning operation is finished. In this state, to perform sustain discharge operation, the transistor SCH is turned off and the transistors SCL and Yg are turned on while a sustain discharge pulse having 0V voltage is applied to the X electrode. Then, a current path is formed from the panel capacitor Cp through the transistor SCL and the body diode of the transistor Ym to the transistor Yg. Then, as shown in FIGS. 2 to 4, the voltage of the Y electrode may be maintained at 0V voltage for a predetermined period during the sustain period of the subfield SF1.

Sequentially, as shown in FIG. 6B, the transistor SCL is turned off and the transistors SCH, Ym, and Yg are turned on. Then, a current path is formed from the transistor Yg through the transistor Ym, the capacitor Csc, the transistor SCH to the panel capacitor Cp. That is, the (VscH−VscL) voltage charged to the capacitor Csc is applied to the Y electrode. Then, the voltage of the Y electrode may be maintained at the (VscH−VscL) voltage for a predetermined time during the sustain period of the subfield SF1.

Meanwhile, as shown in FIG. 4, according to driving waveforms of another exemplary embodiment of the present invention, when the (VscH−VscL) voltage charged to the capacitor Csc is applied to the Y electrode, the Y electrode may be floated by turning of the transistor SCH to thereby maintain the voltage of the Y electrode at the (VscH−VscL) voltage for a predetermined time during the sustain period.

Next, as shown in FIG. 6C, the transistor SCH is turned off and the transistors SCL, Ys, and Ym are turned on. Then, a current path is formed from the transistor Ys through the transistor Ym and the transistor SCL to the panel capacitor Cp. Then, as shown in FIG. 2, the voltage of the Y electrode may be maintained at the Vs voltage for a predetermined time during the sustain period of the subfield SF1.

As described, while a sustain discharge pulse having 0V voltage is applied to the X electrode during a sustain period of a subfield having the lowest weight value, the (VscH−VscL) voltage charged to the capacitor Csc is applied to the Y electrode by controlling turn-on/off of the transistors SCH and SCL of the scan circuit so that the amount of unit light can be reduced compared to the amount of light generated by applying the Vs voltage to the Y electrode during a conventional sustain period, and accordingly, expression of low grayscales may be improved. While 0V voltages have been noted for ease of description above, it is to be understood that it is the relative voltage difference between electrodes that is of interest.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for driving a plasma display device while dividing one frame into a plurality of subfields, the plasma display device including a plurality of first electrodes and a plurality of second electrodes that together perform display operations, the method comprising, in a first subfield having a lowest weight value among the plurality of subfields:
during an address period, selectively applying a first voltage to the plurality of first electrodes and applying a second voltage that is higher than the first voltage to first electrodes to which the first voltage is not applied;
during a first period of a sustain period, applying a third voltage that corresponds to a voltage difference between the first voltage and the second voltage to the plurality of first electrodes; and
during the first period, applying a fourth voltage that is lower than the third voltage to the plurality of second electrodes.

2. The method as claimed in claim 1, further comprising, during the first period, applying a fifth voltage that is higher than the third voltage to the plurality of first electrodes after applying the third voltage to the plurality of first electrodes.

3. The method as claimed in claim 2, further comprising floating the plurality of first electrodes before applying the fifth voltage to the plurality of first electrode after applying the third voltage thereto.

4. The method as claimed in claim 1, further comprising, during a second period after the first period in the sustain period, applying a fifth voltage that is higher than the third voltage to the plurality of second electrodes while applying the fourth voltage to the plurality of first electrodes.

5. The method as claimed in claim 1, wherein the fourth voltage is a ground voltage.

6. The method as claimed in claim 1, wherein the first period is a majority of the sustain period.

7. A driving system for use with a plasma display device including a first electrode, the driving system having a first driver connected to the first electrode, the first driver comprising:
a scan circuit having a first input terminal, a second input terminal, and an output terminal, the output terminal connected to the first electrode;
a first transistor connected between a first power source that supplies a first voltage and the second input terminal;
a second transistor connected between a second power source that supplies a second voltage that is higher than the first voltage and the second input terminal; and
a capacitor having a first end connected to the first input terminal, a second end connected to the second input terminal, and charged with a third voltage, wherein
the first driver turns on the first transistor to apply a voltage at the first input terminal to the first electrode during a first period of a sustain period of a first subfield among a plurality of subfields.

8. The driving system as claimed in claim 7, wherein the first driver alternately turns on the first and second transistors to apply a voltage at the second input terminal to the first electrode during a sustain period of a second subfield among the plurality of subfields.

9. The driving system as claimed in claim 7, wherein the first subfield has the lowest weight value among the plurality of subfields.

10. The driving system as claimed in claim 7, wherein the plasma display device further includes a second electrode that performs display operation with the first electrode, the driving system further comprising a second driver connected to the second electrode, wherein the second driver applies the first voltage to the second electrode during the first period.

11. The driving system as claimed in claim 7, wherein the first driver turns on the second transistor to apply a voltage at the second input terminal to the first electrode during a second period that is subsequent to the first period.

12. The driving system as claimed in claim 7, wherein:
the first driver turns on the second transistor to apply a voltage at the second input terminal to the first electrode by turning on the second transistor during a second period after the first period; and
the scan circuit floats the first electrode during a third period that is provided between the first and second periods.

13. The driving system as claimed in claim 7, wherein the scan circuit further comprises:
a third transistor having a first end connected to the first input terminal and a second end connected to the first electrode; and
a fourth transistor having a first end connected to the second input terminal and a second end connected to the first electrode, wherein
the san circuit applies a voltage at the first input terminal to the first electrode by turning on the third transistor and applies a voltage at the second input terminal to the first electrode by turning on the fourth transistor.

14. The driving system as claimed in claim 7, wherein the first period is a majority of the sustain period.

15. A driving system for use with a plasma display device including a plurality of first electrodes, a plurality of second electrodes that perform display operations with the plurality of first electrodes, a controller that divides one frame into a plurality of subfields, the driving system comprising:
a first driver that selectively applies a first voltage to the plurality of first electrodes and applies a second voltage that is higher than the first voltage to first electrodes to which the first voltage is not applied during an address period of a first subfield among the plurality of subfields, and applies a third voltage to the plurality of first electrodes during a first period of a sustain period of the first subfield, the third voltage corresponding to a voltage difference between the second voltage and the first voltage; and
a second driver that applies a fourth voltage that is lower than the third voltage to the plurality of second electrodes during the first period.

16. The driving system as claimed in claim 15, wherein the first subfield has the lowest weight value among the plurality of subfields.

17. The driving system as claimed in claim 15, wherein the first driver floats the plurality of first electrodes before applying a fifth voltage to the plurality of first electrodes during a second period that is subsequent to the first period, the fifth voltage being higher than the third voltage.

18. The driving system as claimed in claim 15, further comprising, during the first period, the first driver applies a fifth voltage that is higher than the third voltage to the plurality of first electrodes after applying the third voltage to the plurality of first electrodes.

19. The driving system as claimed in claim 15, wherein the fourth voltage is a ground voltage.

20. The driving system as claimed in claim 15, wherein the first period is a majority of the sustain period.
